(19) United States
(12) Patent Application Publication
(10) Pub. No.: US 2008/0257500 A1
(43) Pub. Date: Oct. 23, 2008

(54) Apparatus for the manufacture of a contoured insole construction

(75) Inventor: Guillermo Luis Palmer, Mogi das Cruzes (BR)

Correspondence Address: JERRY RICHARD POTTS, 3248 VIA RIBERA, ESCONDIDO, CA, 92029, US

(73) Assignee: South Cone, Inc., San Diego, CA (US)

(21) Appl. No.: 11/974,270

(22) Filed: Oct. 11, 2007

Related U.S. Application Data
(62) Division of application No. 11/183,468, filed on Jul. 18, 2005.

(51) Int. Cl. B32B 38/10

(52) U.S. Cl. 156/523

(57) ABSTRACT

An apparatus for the manufacture of a contoured insole construction includes a driving mechanism for moving a sheet of continuous material along a cutting path by a pair of closely spaced apart form factor rollers and then using them to simultaneously deform the sheet of continuous material and to guide a flexible continuous knife belt disposed within the cutting path into cutting engagement with the sheet along a desired contour formed by the pair of rollers to separate a contoured single piece footwear construction from the sheet of continuous material.

### RELATED APPLICATIONS

This application is a divisional utility patent application of U.S. utility patent Ser. No. 11/183,468 entitled “Contoured Insole Construction and Method of Manufacturing Same”, by Guillermo Luis Palmer, filed on Oct. 11, 2007.

### BACKGROUND OF THE INVENTION

1. Field of the Invention

This application relates to footwear, and more particularly to a novel contoured insole construction and a method of manufacturing the insole construction.

2. Background of Prior Art

Various insole constructions and methods of manufacturing such insole constructions are well known in the art. However, there is a need for improving the manufacturing process and for providing a single piece contoured insole construction in a fast and highly productive manner.

### BRIEF SUMMARY OF THE INVENTION

An apparatus for the manufacture of a contoured insole construction includes a driving mechanism for moving a sheet of continuous material along a cutting path by a pair of closely spaced apart form factor rollers and then using them to simultaneously deform the sheet of continuous material and to guide a flexible continuous knife belt disposed within the cutting path into cutting engagement with the continuous sheet along a desired contour formed by the pair of rollers to separate a contoured single piece footwear construction from the sheet of continuous material.

### BRIEF DESCRIPTION OF THE DRAWINGS

The above mentioned features and steps of the invention and the manner of attaining them will become apparent, and the invention itself will be best understood by reference to the following description of the preferred embodiment(s) of the invention in conjunction with the accompanying drawings wherein:

FIG. 1 is a diagrammatic view of a method of manufacturing a contoured insole construction in accordance with a preferred embodiment of the present invention;

FIG. 2 is a diagrammatic view of a method of manufacturing a contoured item in accordance with another preferred embodiment of the present invention;

FIG. 3 is a side elevational view of the method of manufacturing the contoured footwear item of FIG. 2;

FIG. 4 is side elevation view of a footwear item, which is constructed in accordance with another preferred embodiment of the present invention;

FIG. 5 is a side elevational view of another footwear item, which is constructed in accordance with yet another preferred embodiment of the present invention;

FIG. 6 is a diagrammatic view of a method of manufacturing a contoured insole construction in accordance with still yet another preferred embodiment of the present invention;

FIG. 7 is a cross sectional view of a holding tray taken substantially along line 7-7 as shown in FIG. 6;

FIG. 8 is a top plane view of a blank insole form utilized in the manufacturing method illustrated in FIG. 6;

FIG. 9 is a top plane view of the top of the holding tray illustrated in FIG. 7;

FIG. 10 is a top plane view of the bottom of the holding tray illustrated in FIG. 7;

FIG. 11 is a flow diagram of the manufacturing method of FIG. 1;

FIG. 12 is a flow diagram of the manufacturing method of FIG. 6; and

FIG. 13 is a diagrammatic view of the intersecting relationship between a pair of sheet cutting path illustrated in FIG. 1.

### DETAILED DESCRIPTION OF THE PREFERRED EMBODIMENTS

An apparatus and method of manufacturing a single piece contoured footwear item are disclosed. The following description is presented to enable any person skilled in the art to make and use the invention. For purposes of explanation, specific nomenclature is set forth to provide a thorough understanding of the present invention. Descriptions of specific applications are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

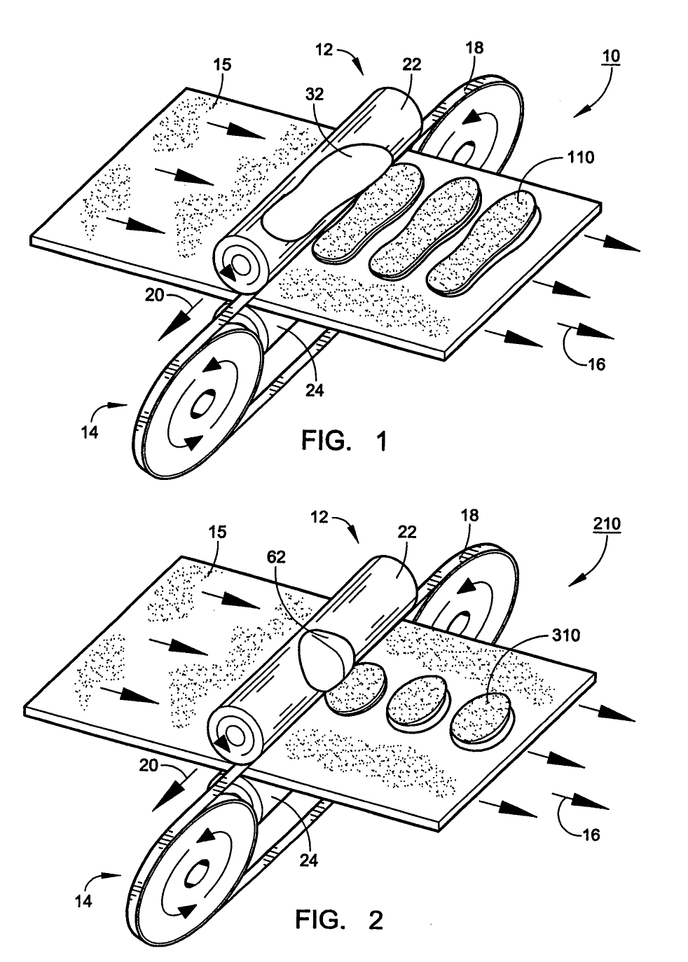

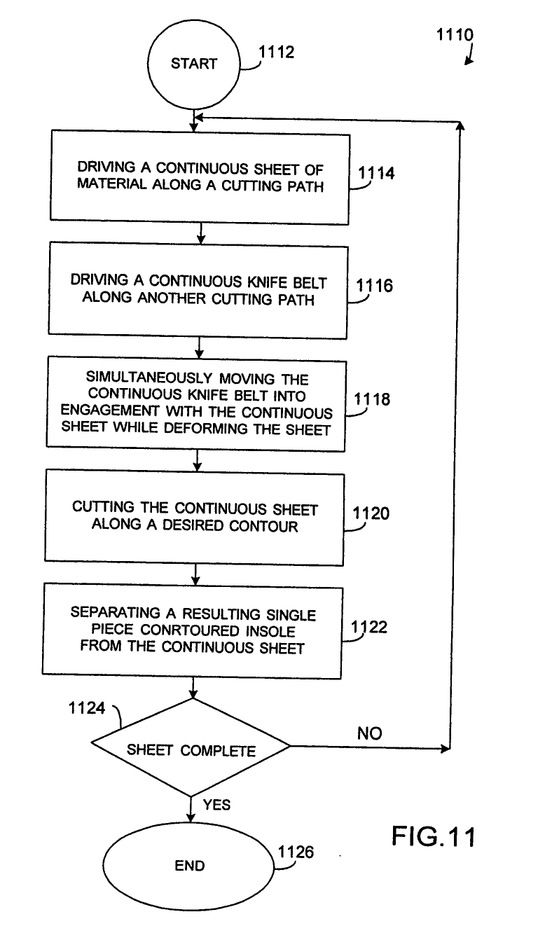

Referring now to the drawings and more particularly to FIG. 1, there is shown an insole construction apparatus 10 for manufacturing a contoured single-piece insole 110 in accordance with a novel method of manufacturing 1110 as best seen in FIG. 11. The footwear making apparatus 10 facilitates the construction of the single-piece insole construction 110 in an extremely fast and highly efficient manner as will be explained hereinafter in greater detail.

Considering now the apparatus 10 in greater detail with reference to FIG. 1, the apparatus 10 generally includes a sheet driving mechanism 12 and a knife belt driving mechanism 14, which cooperate with one another to cause a sheet of foam or EVA material 15 to be driven along a sheet feeding or cutting path 16 and into cutting engagement with a continuous cutting belt 18. The continuous cutting belt 18 is a replaceable cutting belt, which forms part of the knife belt driving mechanism 14.

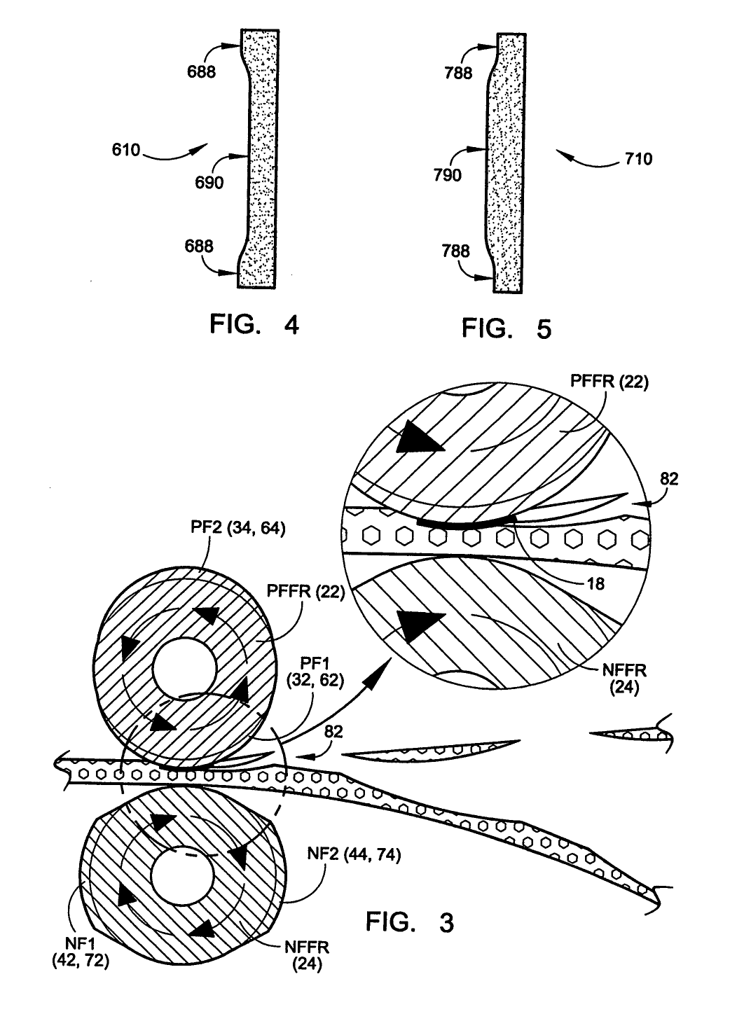

As best seen in FIGS. 1 and 13, the continuous cutting belt 18 travels along a sheet engaging or cutting path 20 which is disposed at about an angle θ relative to the sheet-cutting path 16. In this regard, the sheet-cutting path 16 and the sheet-cutting path 20 intersect with one another at about an angle θ, which is between about 30 degrees and 90 degrees. A more preferred angle θ is between about 45 degrees and 90 degrees, and the most preferred angle θ is about 90 degrees. Although the path 20 is described as a sheet-cutting path, it should be understood that the belt 18 does not engage the continuous sheet 15 except during those times when the belt 18 is flexed under the force of the sheet driving mechanism 12 into engagement with the sheet 15 as best seen in FIG. 3 and as will be explained hereinafter in greater detail.

Considering now the sheet driving mechanism 12 in greater detail with reference to FIG. 1, the sheet driving mechanism 12 is disposed between a continuous sheet supply roller (not shown) and a continuous sheet take up roller (not shown). The supply roller holds a roll of the continuous material 15, which is pulled from a leading edge along the sheet-cutting path 16 through the sheet driving mechanism 12 and onto the take up roller to complete a continuous sheet-feeding path through the sheet driving mechanism 12. A pair of closely spaced apart rollers, including a positive form factor roller 22 and a negative form factor roller 24 continuously engage the continuous sheet 15 with a sufficient frictional force to pull the sheet from the supply roller and drive it along the sheet cutting path 16 onto the take up roller.

As best seen in FIGS. 1 and 3, the positive form factor roller 22 includes a pair of contoured insole forms 32 and 34, which are removably attached to roller 22 by means not shown. The negative form factor roller 24 includes another pair of contoured insole forms 42 and 44, which are removably attached to roller 24. For the purpose of easy in illustrating the orientation of the rollers 22 and 24 and the forms 32, 34, 42, and 44, a generic positive form factor roller PFFR and a generic negative form factor roller NFFR, are illustrated in FIG. 3 with generic positive forms PF1 and PF2 and generic negative forms NF1 and NF2 respectively. In this manner, easy reference may be made to the specific illustrations in FIGS. 1-2 and 4 to understand the relationship between rollers and forms.

As best seen in FIG. 4, the contoured form 32 and contoured form 42 are set apart from one another relative to their rollers 22 and 24 respectively, to engage the sheet of continuous material 15 at different times. In this regard, they are offset by about 90 degrees so that upon a ninety-degree rotation of the rollers 22 and 24 (which roll in unison), either a positive form or a negative form will be engaging the sheet 15 of continuous material. This rotational offset provides sufficient frictional force on the continuous sheet 15 to pull it from the supply roller and to drive it along the sheet-cutting path 16 to be taken up on the take up roller. Those skilled in the art will understand that by offsetting the forms 32 and 34 on the positive form factor roller 22 by about 180 degrees, a sufficient gap is provided along the continuous sheet 15 to separate individual ones of the single-piece contoured footwear items 110 produced by the cutting action of the continuous knife belt 18 as will be explained hereinafter in greater detail.

Considering now the method 1110 of manufacturing the single-piece contoured footwear item 110 in greater detail with reference to FIGS. 1, 4, 8 and 11, the manufacturing process begins at a start step 1112 where an operator sets up the apparatus 10 as described earlier with the sheet of continuous material 15 in engagement with the sheet driving mechanism 12 and extending between the feed roller and the take up roller. The driving mechanism 12, at a driving step 1114, is then actuated to cause the sheet of continuous material 15 to be driven along the sheet cutting path 16 by the rollers 22 and 24 respectively.

At about the same time as the sheet of continuous material 15 begins to be driven along the sheet cutting path 16, the knife belt driving mechanism 14 is also actuated at a belt driving step 1116, to cause the continuous knife belt 18 to be driven along the sheet cutting path 20.

In unison now, as the rollers 22 and 24 engage the sheet 15, the forms 32 and 34 in an alternating rhythm flex the continuous knife belt 18 into engagement with the sheet 15, which is simultaneously deformed in the same alternating manner by the forms 32 and 34 respectively. In this regard, as one of the forms, for example form 32 deforms a portion of the sheet 15 into a desired contoured shape, the deformed section of the sheet 15 is brought into simultaneous engagement with the cutting edge of the knife belt 18. Accordingly, at a cutting step 1120 the cutting edge of the knife belt 18 engages the sheet 15 and deviates from the path 20 to follow along a deform path indicated generally at 82 (FIG. 3) which is defined by the contoured protuberance provided by the form 32.

As the sheet 15 continues to move along the sheet cutting path 16 while in cutting engagement with the knife belt 18, which is now traveling along the deform path 82, the cutting action of the knife belt 18 separates the deformed section 110 from the sheet 15 at a separating step 1122. The separated deformed section, which has been removed from the sheet 15, is the single-piece contoured footwear item 110.

At a decision step 1124 a determination is made whether to repeat the steps 1114, 116, 1118, 1120, and 1122 to manufacture another single-piece contoured footwear item 110. This determination is made based upon the action of a trip switch (not shown) that provides an indication that there is an insufficient amount of the continuous sheet 15 to continue the manufacturing process. If there is a sufficient amount of continuous sheet 15, the process returns to step 1114 and continues as previously described. If there is not a sufficient amount of continuous sheet 15, the process goes to an end step 1126 that causes the sheet driving mechanism 12 and the knife belt driving mechanism 14 to be stopped. The manufacturing process 1110 is an automated process.

Although in this preferred embodiment the separate deformed section is described as a single-piece contoured footwear item 110, it will be understood by those skilled in the art that other contoured items could also be manufactured in the same manner. For example, in FIG. 2 there is illustrated an apparatus 210, which is identical to apparatus 10 except that it includes different forms 62 and 64 respectively, which facilitate the manufacture of an article of manufacture, such as the article 310. It is also contemplated that the forms attached to the rollers can be constructed to facilitate the manufacture of items with different contoured shapes. For example as best seen in FIG. 4, there is illustrated a contoured footwear item 610 which includes a raised outer lip perimeter region indicted generally at 688 and a lower contoured foot-receiving base region 690 bounded by the raised outer lip perimeter region 688. As another example as best seen in FIG. 5, there is illustrated a contoured footwear item 710, which includes a raised foot receiving base region 790 bounded by a lower outer lip perimeter region 788. Therefore, there in no intention of limiting the scope of the preferred embodiment to the manufacturer of only footwear items as other items of manufacture having a contoured form are contemplated within the true scope and spirit of the present invention.

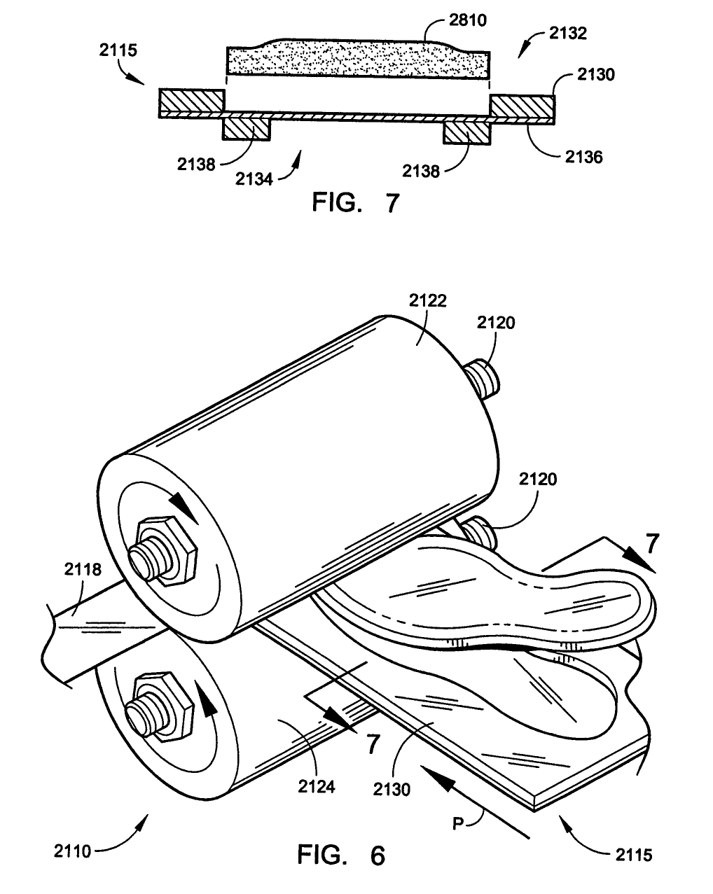

Referring now to the drawings and more particularly to FIG. 6, there is illustrated an insole construction apparatus 2110 for manufacturing a contoured single-piece insole 2810 as best seen in FIG. 7 in accordance with a novel method of manufacturing 910. The footwear making apparatus 2110 facilitates the construction of the single-piece insole construction 2810 in a semi-automatic manner as will be explained hereinafter in greater detail.

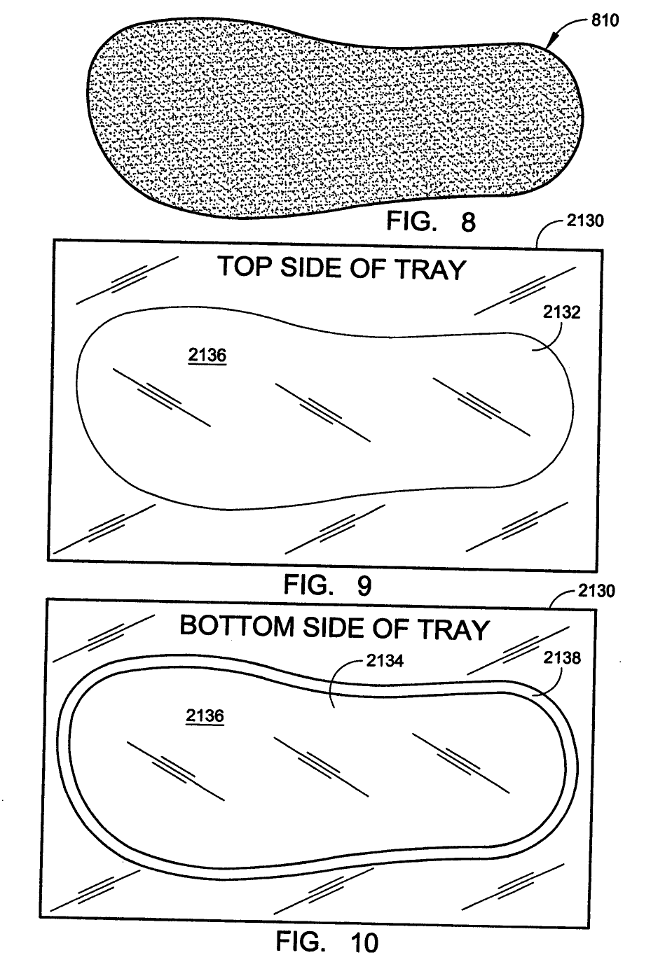

Considering now the apparatus 2110 in greater detail with reference to FIG. 6, the apparatus 10 generally includes a driving mechanism 2120 coupled to a pair of closely spaced drive rollers 2122 and 2124 respectively. The drive rollers 2122 and 2124 cooperate with one another to cause an insole carrier mold 2115 (which is introduced into a front nip between the rollers 2122, 2124 to be sandwiched therebetween and pulled along a cutting path P into proximity of a cutting blade 2118. In this regard, as the mold 2115 is pulled and sandwiched between the rollers 2122 and 2124, a blank insole 810 (FIG. 8), carried by the mold 2115, is distorted into a predetermined distorted shape. The predetermined distorted shape is so distorted so as to allow a portion of the blank insole 810 to engage the blade 2118 with a sufficient force to cut away a desired portion of the blank insole 810, which in turn, results in a single-piece contoured insole, such as the contoured insole 2810, being formed.

After the distorted portion of the blank insole 810 has been cutaway and separated, the mold 2115 continues along the path P and into the nip of another pair of rollers (not shown) which in turn cause the mold 2115 and contoured insole 2810 by means (now shown) to be discharge from the apparatus 2110.

Considering now the mold 2115 in greater detail with reference to FIGS. 7-10, the mold 2115 generally includes a generally rectangularly shaped base member 2130 with a centrally disposed topside cutout 2132 and a centrally disposed bottom side cutout 2134. The topside cutout 2132 and the bottom side cutout 2134 are disposed opposite to one another and are spaced from one another by a thin sheet of resilient material 2136.

The topside cutout 2132 and the bottom side cutout 2134 are configured in the shape of an insole in order to facilitate holding, deforming, and cutting the blank insole 810. In this regard, the topside cutout 2132 that has a sufficient depth dimension to retain the insole 810 in place within the carrier mold 2115 as it passes between the rollers 2122 and 2124 as previously described.

As best seen in FIG. 7, the bottom side cutout 2134 has a deforming member 2138 that extends along the entire perimeter of the cutout 2134. The deforming member 2138 is composed of a hard non-resilient material that will not deform or lose its shape when the mold 2115 passes between the roller 2122 and 2134. In this regard, the insole 810 deforms in shape when pressed against the deforming member 2138 by the rollers 2122 and 2124. More particularly, an outer portion of the insole blank 810 is pushed under the force of the rollers 2122, 2124 and distorted by the distorting member 2138 to a position that extends above the upper plane of the mold carrier 2115. In this regard, as the mold carrier 2115 passes below the cutting blade 2118, the blade 2118 severs the distorted outer portion of the insole blank 810 that extends above the upper plane of the mold carrier 2115 from the blank 810. As a result of removing this outer section from the blank 810 an contoured insole, such as the contoured insole 2810 is formed.

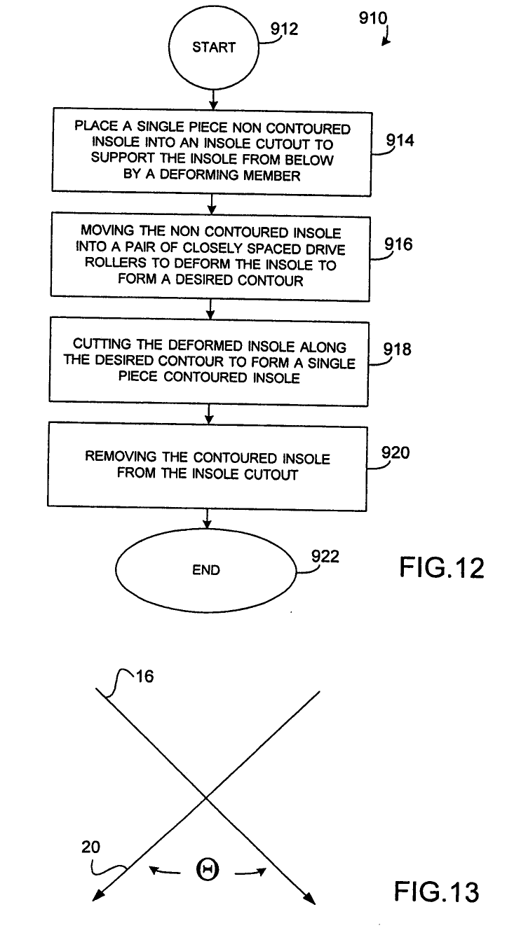

Considering now the novel method of using the apparatus 2110 to manufacture a contoured insole, such as the contoured insole 610, in greater detail with reference to FIG. 12, the manufacturing process begins at a start step 912 where a user activates the apparatus 2110 to cause the drive mechanism 2120 to drive the rollers 2122 and 2124.

Next, at a placing step 914, a user places a single piece non-contoured insole blank, such as the insole blank 810, into the mold carrier 2115. More specifically, the user places the insole blank 810 into the upper cutout 2132 so that the blank 810 is supported from below by the thin sheet 2136 and the deforming member 2138.

The user then moves the mold carrier 2115 into the front nip between the rollers 2122 and 2124 allowing the roller to grasp and pull the carrier 2115 along the cutting path P. In this regard, the carrier 2115 is pulled between the rollers 2122 and 2124, which in cooperation with the distorting member 2138, cause an inner portion of the insole blank 810 to be distorted and pushed above the plane of the carrier 2115 as the carrier exits the rear nip from between the rollers.

Next, at a cutting step 918, the blade 2118, which is positioned at the rear nip of the rollers 2122 and 2124, slices the deformed insole blank 810 along a desired contour form resulting from distorting the blank 810 to form a single piece contoured insole, such as the contoured insole 2810.

Finally, when the carrier 2115 is discharged from the apparatus 2110, the user, at a removing step 920, removes the contoured insole from the carrier 2115. The user then places another blank insole into the now empty insole cutout 2132 and repeats the process to form another contoured insole.

While this invention has been shown fully and completely with special emphasis on certain preferred embodiments, it should be understood that within the scope of the appended claims the invention may be practiced otherwise than as specifically described herein.

1. An insole construction apparatus, comprising:
a sheet driving mechanism including a positive form factor drive roller and a negative form factor drive roller for continuously engaging a sheet of material to transport it along a cutting path;
a belt driving mechanism for causing a flexible knife belt to be driven continuously along a sheet engaging path; and
wherein at least one of said positive form factor drive roller and said negative form factor drive roller include at least one contoured form member for simultaneously deforming said sheet of material and guiding said flexible knife belt into cutting engagement with the deformed sheet of material to form a single-piece contoured footwear construction.

2. The insole construction apparatus according to claim 1, wherein said single-piece contoured footwear construction is a contoured insole.

3. The insole construction apparatus according to claim 2, wherein said contoured insole includes a raised outer lip perimeter region and a lowered foot-receiving base bounded by said raised outer lip perimeter region.

4. The insole construction apparatus according to claim 2, wherein said single-piece contoured insole includes a raised foot receiving base bounded by a lowered outer lip perimeter region.

5-7. (canceled)

8. The insole construction apparatus according to claim 1, wherein said contoured single-piece insole includes a raised outer lip perimeter region and a lowered foot-receiving base region bounded by said raised outer lip perimeter region.

9. The insole construction apparatus according to claim 1, wherein said contoured single-piece insole includes a raised foot receiving base region bounded by a lowered outer lip perimeter region.

10-17. (canceled)

18. The insole construction apparatus according to claim 1, wherein said flexible continuous belt knife travels along another cutting path; and
wherein said cutting path and said another cutting path intersect one another at about an angle of θ degrees.

19. The insole construction apparatus according to claim 18, wherein θ is between about 30 degrees and 90 degrees.

20. The insole construction apparatus according to claim 19, wherein a more preferred θ is between about 45 degrees and 90 degrees.

21. The insole construction apparatus according to claim 20, wherein a most preferred θ is about 90 degrees.

22. (canceled)
